(19) United States
(12) Patent Application Publication
(10) Pub. No.: US 2003/0062133 A1
(43) Pub. Date: Apr. 3, 2003

(54) Laminated core machining apparatus

(76) Inventors: Kuniyasu Shirai, Bisai-shi (JP); Takuya Sato, Nagano-ken (JP)

Correspondence Address: David T. Nikaido, RADER, FISHMAN & GRAUER, PLLC, 1233 20th Street, NW, Suite 501, Washington, DC, 20036, US

(21) Appl. No.: 10/247,508

(22) Filed: Sep. 20, 2002

(30) Foreign Application Priority Data
Sep. 25, 2001 (JP) 2001-291252

(51) Int. Cl. B31F 1/00

(52) U.S. Cl. 156/459; 29/732

(57) ABSTRACT

In order to set a rotating angle in a laminating station to an arbitrary angle, and to perform a high-speed operation while keeping the strength of an angle index head, a laminated core machining apparatus M comprises a press machine 1, a non-uniform motion head 10, an angle index head 7 and a gear system 6. That is, the non-uniform motion head 10 converts a drive of the press machine 1 from a uniform rotation into a non-uniform rotation. The angle index head 7 is connected to the non-uniform motion head 10 via a coupling 20. The gear system 6 is connected to the angle index head 7 while being connected to a rotary driving section of a laminating station 51 of a die 5. In the laminating station 51, an intermittent rotation is made by the angle index head 7, and the rotating angle is arbitrarily set by the combination of four kinds of gears included in the gear system 6. Further, a stop period (section) is provided by the non-uniform motion head 10 before a feed timing of the press machine is completed.

### BACKGROUND OF THE INVENTION

(1) Field of the Invention

The present invention relates to a laminated core machining apparatus, which laminates a strip material while forwardly feeding it. More particularly, the present invention relates to a laminated core machining apparatus, which is constructed so that a laminated member is rotatable in a die in a laminating process.

(2) Description of the Prior Art

In general, a laminated core, for example, a motor core is formed in the following manner. More specifically, a thin-plate strip material is carried by a feeder, and then, is machined in each die station mounted to a press machine. Further, the strip material is sequentially laminated while being punched as a sheet of laminated plate in a laminating station. As described above, the laminated plate has been formed in a manner that the strip material is machined in each station, and is punched every one sheet by a shear. In this case, however, when molding the strip material, non-uniformity occurs in a thickness of the laminated plate. For this reason, in the conventional case, the strip material is sequentially rotated at a predetermined angle in the laminating station, and is subjected to pressure welding after the rotation is stopped. By doing so, the thickness of each laminated plate is made uniform while the laminated plate is caulked. Further, the press machine has been mounted with an angle index head as the equipment for rotating the laminated plate (or a laminated member in which a plurality of laminated plates is laminated) in the laminating station. A rotating output from the press machine is transmitted, and thereby, the angle index head is driven.

The angle index head is driven so that it can be rotated at a predetermined angle within a range of feed timing of the press machine (in general, crank angle from 270° to 90°). When the drive of the angle index head is completed (i.e., the angle exceeds a crank angle of 90°), the press machine goes into its machining timing (in general, crank angle from 90° to 270°), and thereafter, machining is carried out in each station. In particular, in the laminating station, a plurality of laminated plates is subjected to pressure welding and caulking.

Further, the angle index head includes a cam section having a cam driven by a camshaft, and an indexing section having an output shaft and a plurality of cam rollers engaging with the cam section. The cam roller is rotated by the cam section at a predetermined angle with respect to the center of rotation, and thereby, the output shaft is rotated at a predetermined angle so that angle indexing can be carried out.

In a conventional laminated core machining apparatus, the angle index head has been mechanically constructed having the cam section and the index section as described above, or an angle has been set by a servomotor. In addition, the above angle index heads are both connected to a driving part of the press machine via a transmission member. Thus, the angle index head is continuously rotated at a uniform speed in synchronous with a rotation of the driving part of the press machine. On the other hand, the output shaft of the angle index head has been intermittently driven in the following manner. That is, the output shaft of the angle index head is rotated at a predetermined angle during feed timing (crank angle from 270° to 90°) of the press machine, and is in a rotation stopped state during machining timing (crank angle from 90° to 270°).

However, in the above conventional laminated core machining apparatus, that is, in the angle index head having the mechanical structure including the cam section and the indexing section, it is impossible to set a rotating angle to an arbitrary angle. Moreover, although the rotating angle is set to an arbitrary angle by the servomotor, there is the limit in a high-speed operation; as a result, it is impossible to achieve an improvement of productivity. Further, the timing when the rotation of the output shaft of the angle index head is stopped coincides with the feed completion time (crank angle of 90°) of the feed timing. For this reason, the conventional machining apparatus goes into a machining timing at the same time when angle indexing is completed. In other words, a pilot punch arranged in an upper die quickly enters a laminated member when the laminated member is rotated and the rotation is stopped. In particular, in the case of operating the press machine at a high speed, the rotating laminated member can not be immediately secured at a rest position by the rotation stop; as a result, a run-out (vibration) is generated in the laminated member. During the generation of the run-out, when the pilot punch of the upper die enters the laminated member, the following problem has arisen. That is, in the case of inserting the pilot punch into a predetermined position (e.g., hole) of the laminated member, the pilot punch collides with another portion of the laminated member; as a result, there is a possibility that the pilot punch is broken and damaged. For this reason, a high-speed operation can not be achieved.

As one course to achieve the above high-speed operation, the following course is taken. More specifically, the indexing section is constructed so that the output shaft of the angle index head is set to 180° or less (e.g., 150°, 120°, etc.) with respect to a rotation of 180° of an input shaft. Further, the rotation of the output shaft is completed at a timing faster than the feed timing of the press machine so as to provide the difference in the rotation stop between the input and output shafts, and thereby, a stop time is provided. During the stop time, it is possible to attenuate the run-out generated in the laminated core. However, in this case, the index angle of the indexing section is made small, and thereby, this is a factor of causing a reduction of strength of the angle index head itself; for this reason, it is impossible to achieve a high-speed operation.

### SUMMARY OF THE INVENTION

The present invention has been proposed in order to solve the above problem. Accordingly, an object of the present invention is to provide a laminated core machining apparatus, which can arbitrarily set a rotating angle of a laminated member while achieving a high-speed operation, and further, can perform machining without causing a run-out of the laminated member generated in operating at a high speed.

In order to solve the above problem, according to one aspect of the present invention, there is provided a laminated core machining apparatus, which comprises: a press machine; a feeder for feeding a strip material to the press machine; and an angle index head outputting an intermittent rotation when a drive from the press machine is transmitted thereto, and carries out laminating in a manner of sequentially rotating a laminated member in a laminating process when forwardly feeding the strip material so that a laminated core can be formed,

wherein the apparatus is connected with an angle index head for rotating the laminated member and a gear system connected to the angle index head and having a gear assembly capable of arbitrarily setting an index angle, in the laminating process.

Therefore, since the angle index head is connected with the gear system so that the laminated member can be rotated at a predetermined angle, the number of gear teeth of the above gears is arbitrarily combined, and thereby, it is possible to arbitrarily set the rotating angle of the laminated member. In addition, the machining apparatus is mechanically connected to the press machine; therefore, a high-speed operation can be achieved.

Further, the gear system is constructed so that the rotating angle of the output driving shaft is set by the combination of four types of gears. Thus, when the output angle of the angle index head is set to θI, and each number of gear teeth of the gears is set as N1, N2, N3, and N4, the rotating angle θI of the output driving shaft of the gear system is obtained from the following equation of θ=θI×(N1×N3)/(N2×N4). The combination of four gears having arbitrary number of teeth is changed, and thereby, it is possible to set an arbitrary rotating angle, and to achieve fine adjustment to the target rotating angle.

Further, according to another aspect of the present invention, there is provided a laminated core machining apparatus, which comprises: a press machine; a feeder for feeding a strip material to the press machine; and an angle index head outputting an intermittent rotation when a drive from the press machine is transmitted thereto, and carries out laminating in a manner of sequentially rotating a laminated member in a laminating process when forwardly feeding the strip material so that a laminated core can be formed,

wherein the apparatus is connected with an angle index head for rotating the laminated member and a gear system connected to the angle index head and having a gear assembly capable of arbitrarily setting an index angle, in the laminating process

the angle index head is connected via a non-uniform motion mechanism with respect to a rotating output of the press machine, an output shaft of the non-uniform motion mechanism has a forward feed timing rotating faster than an input shaft of the non-uniform motion mechanism so that a stop period can be provided between a rotation stop time of the output driving shaft of the gear system and a feed stop time of a feed timing.

Therefore, in the laminated core machining apparatus of the present invention, the rotation output of the press machine is transmitted to the non-uniform motion mechanism. In the non-uniform motion mechanism, the rotation output of the input shaft rotating at a uniform speed is transmitted to the output shaft at a non-uniform speed. Thus, the position rotating faster than the input shaft is set during the feed timing of the press machine, and thereby, the output driving shaft of the gear system connected to the angle index head reaches the rotation completion position before the feed timing is completed. As a result, the output driving shaft of the gear system has the stop period until the feed timing is completed after the rotation of the output driving shaft of the gear system is completed. Therefore, the run-out by the rotation of the laminated member is attenuated during the stop period, and in the case where the upper die pilot punch goes into the laminated member, it goes into the predetermined position, so that the pilot punch has no interference and collision with other portions of the laminated member. Therefore, the mechanically connected laminated core machining apparatus further makes it possible to achieve a high-speed operation.

In the non-uniform motion mechanism, when the input shaft (rotary shaft of the press machine side) of the non-uniform motion mechanism is rotated, the rotation output is transmitted to the output shaft (rotary shaft of the angle index head side) positioned eccentrically with the input shaft by the connecting lever. Therefore, the uniform rotation of the input shaft of the non-uniform motion mechanism is outputted as the non-uniform rotation of the output shaft of the non-uniform motion mechanism. In other words, the output driving shaft of the gear system connected to the output shaft of the non-uniform motion mechanism via the angle index head has a forward feed timing with respect to the feed timing of the press machine. Thus, the forward feed timing is set during the feed timing of the press machine, and thereby, the time rotating and stopping the laminated member comes faster than the completion of the feed timing. Therefore, the stop period is provided without making small the index angle of the angle index head. By doing so, it is possible to attenuate the run-out by the rotation of the laminated member during the stop period, and to achieve a high-speed operation without reducing the strength of the angle index head itself.

### BRIEF DESCRIPTION OF THE DRAWINGS

The above and further objects and features of the present invention will become more fully apparent from the following detailed description with reference to the accompanying drawings in which:

FIG. 1 is a top plan view schematically showing a laminated core machining apparatus according to one embodiment of the present invention;

FIG. 2 is a rear view showing a non-uniform motion head and an angle index head shown in FIG. 1;

FIG. 3 is a cross-sectional view taken along the line III-III shown in FIG. 1;

FIG. 4 is a cross-sectional view showing the non-uniform motion head shown in FIG. 2 ;

FIG. 5 is a cross-sectional view taken along the line V-V shown in FIG. 4;

FIG. 6 is a graph showing non-uniform motion of an output shaft;

FIG. 7 is a graph showing a crank angle of a press machine;

FIG. 8 is a side view showing a gear system shown in FIG. 2;

FIG. 9 is a top plan view schematically showing a laminated core machining apparatus according to another embodiment of the present invention excepting the non-uniform motion head shown in FIG. 1;

FIG. 10 is a top plan view schematically showing a laminated core machining apparatus according to one embodiment of the present invention including two systems, that is, the angle index head and the gear system in FIG. 1;

FIG. 11 is a partially top plan view showing a strip material in the case of laminating a stator S and a rotor R; and

FIG. 12 is a top plan view schematically showing a laminated core machining apparatus according to another embodiment of the present invention excepting the non-uniform motion head shown in FIG. 11.

### DETAILED DESCRIPTION OF THE PREFERRED EMBODIMENTS

One embodiment of the present invention will be described below with reference to the accompanying drawings.

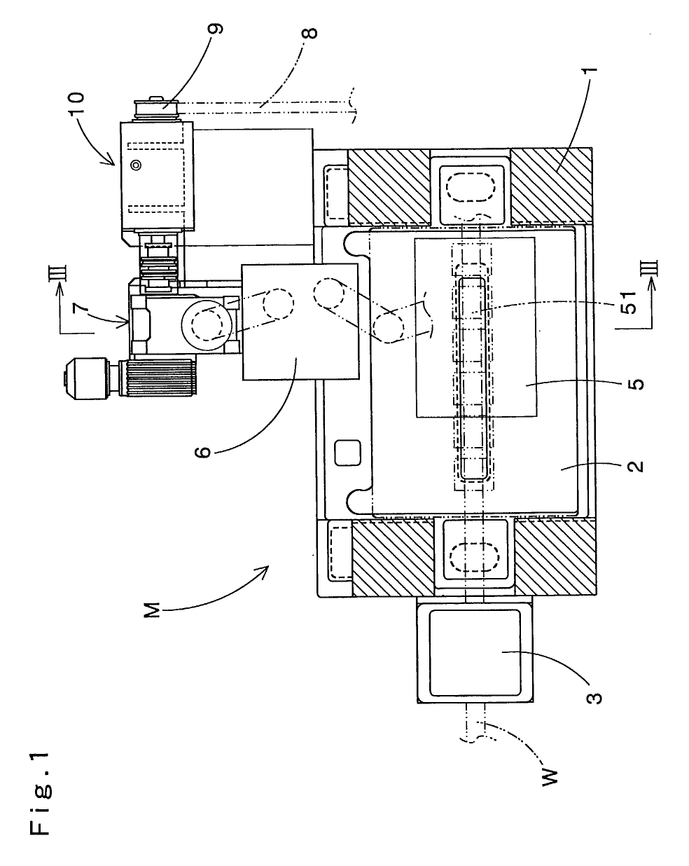

As shown in FIG. 1, according to the embodiment, a laminated core machining apparatus (hereinafter, referred to as machining apparatus) M comprises a press machine 1 used as machining apparatus, a feeder 3, a die 5, a gear system (mechanism) 6, an angle index head 7, and a non-uniform motion head 10. More specifically, the feeder 3 feeds a strip material W to the press machine 1, and the die 5 is mounted on a bolster plate 2 of the press machine. Further, the gear system 6 is connected to a laminating station (laminating process) 51 of the die 5 when receiving a drive from the press machine 1, and thereafter, is driven. The angle index head 7 is connected to the gear system 6. The non-uniform motion head 10 is interposed between the angle index head 7 and a driving section of the press machine 1. The thin-plate strip material W is fed into the press machine 1 by the feeder 3, and then, is sequentially machined in each station of the die 5 mounted in the press machine 1. Thereafter, a laminated sheet (core) laminated for each sheet in the laminating station 51 is caulked, and thereby, a laminated core is formed. In the laminating station 51, the core is sequentially rotated at a predetermined angle, as one sheet is laminated in the die 5, and thereafter, is subjected to caulking.

The die 5 mounted on the bolster plate 2 of the press machine 1 is provided with each machining station for sequentially machining the strip material W fed. The laminating station 51, which punches a core from the strip material W and laminates it, is arranged as the final station.

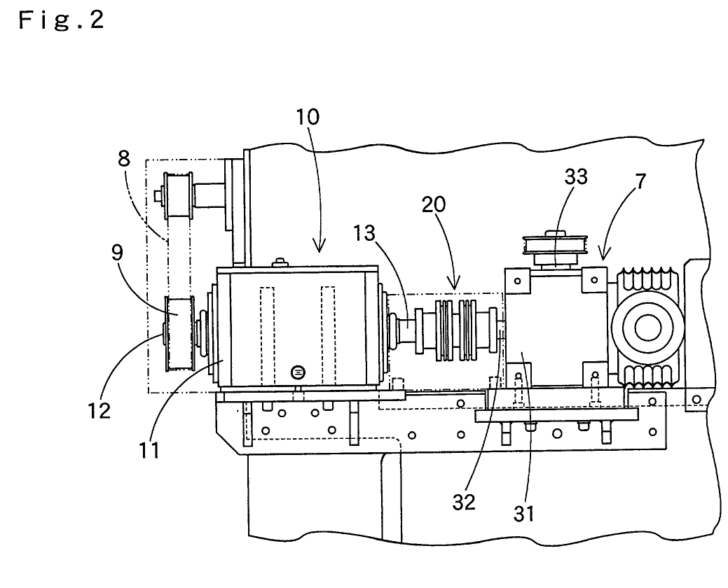

On the other hand, as shown in FIG. 2, the non-uniform motion head 10 is arranged on a rear portion of the press machine 1 in the following manner. An input shaft 12 is connected via a belt 8 from one end of a driving section (i.e., crank shaft (not shown)) of the press machine 1, and an output shaft 13 is connected to the angle index head 7 arranged on the rear portion of the press machine 1 via a coupling 20.

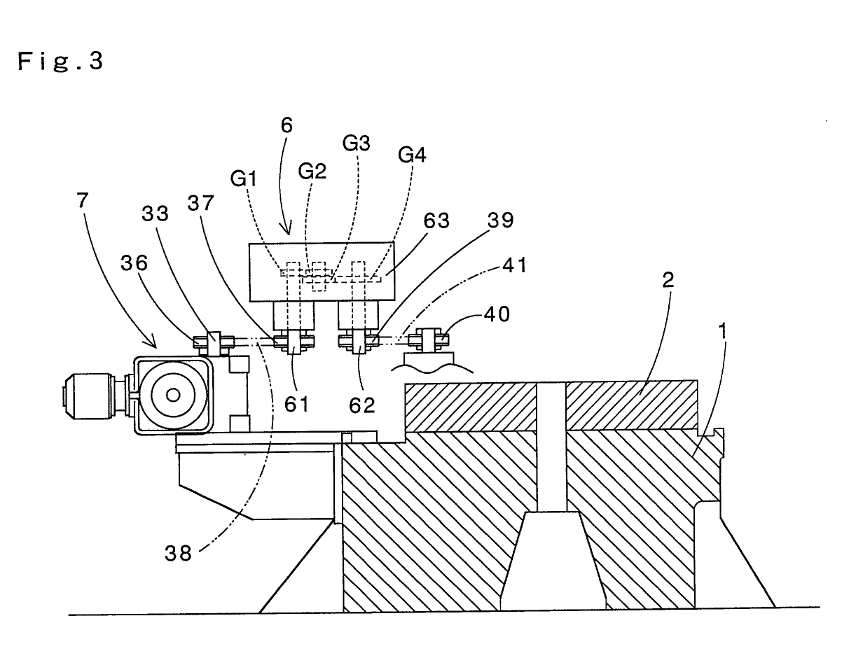

Moreover, as shown in FIG. 1 and FIG. 3, a driving shaft 33 of the angle index head 7 is connected to an input shaft 61 of the gear system 6 having combined four gears (G1, G2, G3, and G4). When an output driving shaft 62 of the gear system 6 is connected to the laminating station 51, the laminating station 51 rotates and drives the laminated member along a rotating angle of the output driving shaft 62.

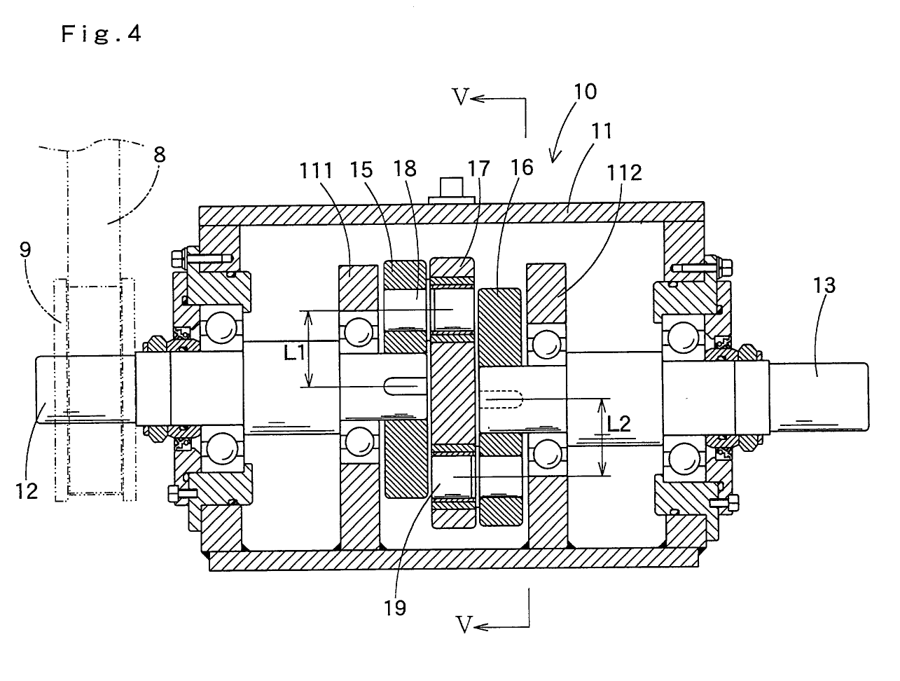

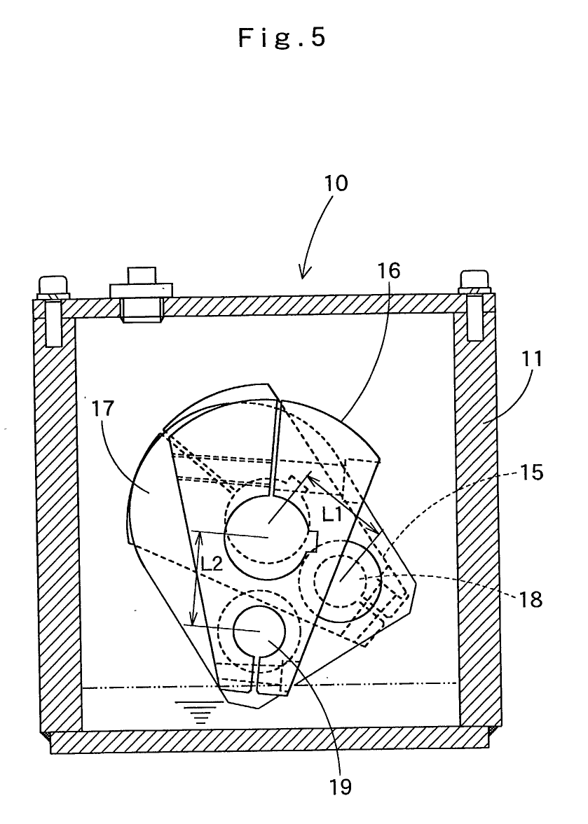

As seen from FIG. 4 and FIG. 5, the non-uniform motion head 10 has a main body case 11, an input shaft 12 and an output shaft 13. More specifically, the main body case 11 has an internal hollow. Further, the input shaft 12 is inserted through the main body case 11 from one direction to the axial direction, and the output shaft 13 is inserted through the main body case 11 from another direction to the axial direction. One end of the input shaft 12 is mounted with a pulley 9 projecting outwardly from the main body case 11, and the other end thereof is provided with a first rotating lever 15. The first rotating lever 15 is supported to a support wall 111 extending from an internal bottom wall of the main body case 11, and is formed into a substantially sector shape. Further, the first rotating lever 15 is rotatably supported together with the input shaft 12.

One end of the output shaft 13 is connected to the coupling 20 (see FIG. 2) outside the main body case 11, and the other end thereof is provided with a second rotating lever 16. In the main body case 11, the second rotating lever 16 is supported to a support wall 112 extending from the internal bottom wall of the main body case 11, and is formed into a substantially sector shape. Further, the second rotating lever 16 is mounted so as to face the first rotating lever 15 mounted to the input shaft 12.

A connecting lever 17 is interposed between the first and second rotating levers 15 and 16. One end of the connecting lever 17 is rotatably connected to the first rotating lever 15 via a first connecting pin 18 arranged at a position eccentric with the input shaft 12. The other end of the connecting lever 17 is rotatably connected to the second rotating lever 16 via a second connecting pin 19 arranged at a position eccentric with the output shaft 13.

An axial center distance L1 and an axial center distance L2 are set to the same dimension. The axial center distance L1 is a distance between the center of rotation of the first rotating lever 15 (axis of the input shaft 12) and that of the first connecting pin 18. On the other hand, the axial center distance L2 is a distance between the center of rotation of the second rotating lever 16 (axis of the output shaft 13) and that of the second connecting pin 19. The input and output shafts 12 and 13 are arranged on a mutually eccentric position, and are supported to the main body case 11.

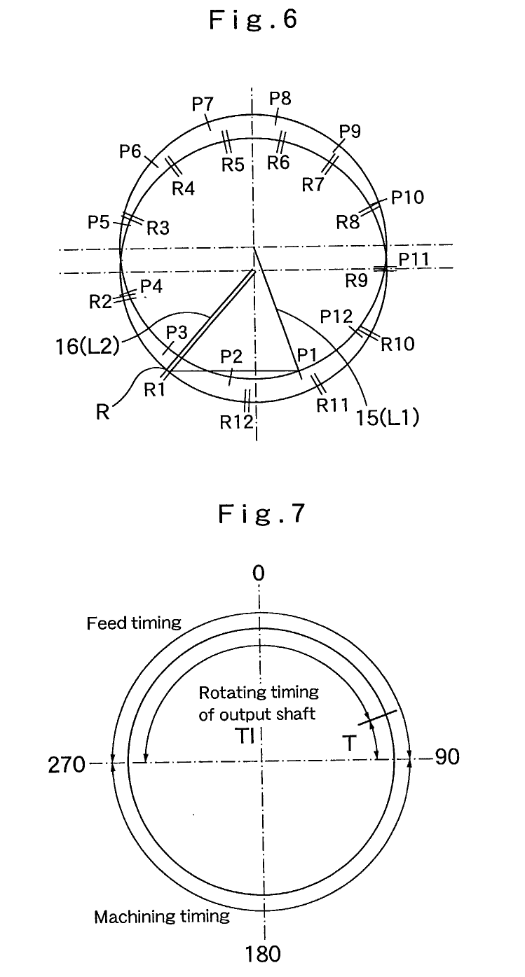

The input shaft 12 is supported to the main body case 11 mounted with the pulley 9 and the support wall 111 at one end of the input shaft 12 via a bearing; on the other hand, the output shaft 13 is supported to the main body case 11 and the support wall 112 via a bearing. By doing so, the rotation of the driving section of the press machine 1 is transmitted sequentially to the input shaft 12, the first rotating lever 15, the first connecting pin 18, the connecting lever 17, the second connecting pin 19, the second rotating lever 16 and the output shaft 13. The input shaft 12 and the output shaft 13 are situated at an eccentric position, and the connecting lever 17 is connected to the first and second rotating levers 15 and 16 at the eccentric position with respect to the axial center. By doing so, during one rotation, the connecting lever 17 can make a rotating position later than the rotation of the input shaft and a rotating position faster than that; therefore, the connecting lever 17 becomes non-uniform speed so as to give a rotation output to the output shaft 13. A relation at that time is shown in FIG. 6.

In FIG. 6, since the input shaft 12 is driven at a uniform speed, a locus P of the axial center of the first connecting pin 18 is shown at each position (P1 to P12) with equal intervals, that is, at an angle of 30°. In this case, the locus is shown by one end of the axial center distance L1 (solid line) between the center of rotation of the first rotating lever 15 and the axial center of the first connecting pin 18. On the other hand, since the output shaft 13 is situated at a position eccentric with the input shaft 12, a locus R of the axial center of the second connecting pin 19 is shown at each position (R1 to R12) corresponding to the angular intervals of 30° of the input shaft 12 by interposing the connecting lever 17. In this case, the locus R is shown by one end of the axial center distance L2 (double line) between the center of rotation of the second rotating lever 16 and the axial center of the second connecting pin 19. Further, in FIG. 6, since the locus R (R1 to R12) is positioned as one vertex so as to form an approximately triangular shape, and is shown with in-equal intervals, the output shaft 13 is rotated at an in-equal speed. Therefore, during one rotation, the faster rotating position (R3 to R8) is set within a range of crank angle feed timing, and thereby, in the feed timing, a rotation timing T1 of the output shaft 13 is outputted at a rotation faster than the rotational speed of the input shaft 12, from seeing a graph shown in FIG. 7.

In the case where the input shaft 12 is rotated within a range of the crank angle feed timing (270° to 90°), the feed timing completion (crank angle of 90°) of the output shaft 13 comes faster than the feed timing completion (crank angle of 90°) of the input shaft 12 (T1 in FIG. 7). Therefore, the output shaft 13 becomes a rotation stopped state (stop period T in FIG. 7) until the input shaft 12 reaches to the crank angle of 90°. More specifically, for example, when the output shaft 13 is rotated by an angle of 180° while the input shaft 12 is rotated by an angle of 160° during the feed timing, the output shaft 13 is stopped until the input shaft 12 is rotated by the crank angle 70° to 90°, that is, by a crank angle of 20°.

The output shaft 13 of the non-uniform motion head 10 is connected to a camshaft 32 projected from the main body case 31 of the angle index head 7 via the coupling 20 (see FIG. 2). The rotation of the output shaft 13 of the non-uniform motion head 10 is transmitted to a driving shaft 33 of the angle index head 7. In this embodiment, the angle index head 7 employs the following known angle index mechanism. More specifically, the angle index head 7 has a cam section and an angle index section. The cam section has a cylindrical cam connected to the camshaft 32. The angle index section has a cam roller, which is engaged with the cylindrical cam and is arranged at plural equal intervals, and rotates a driving shaft 33 at a predetermined angle.

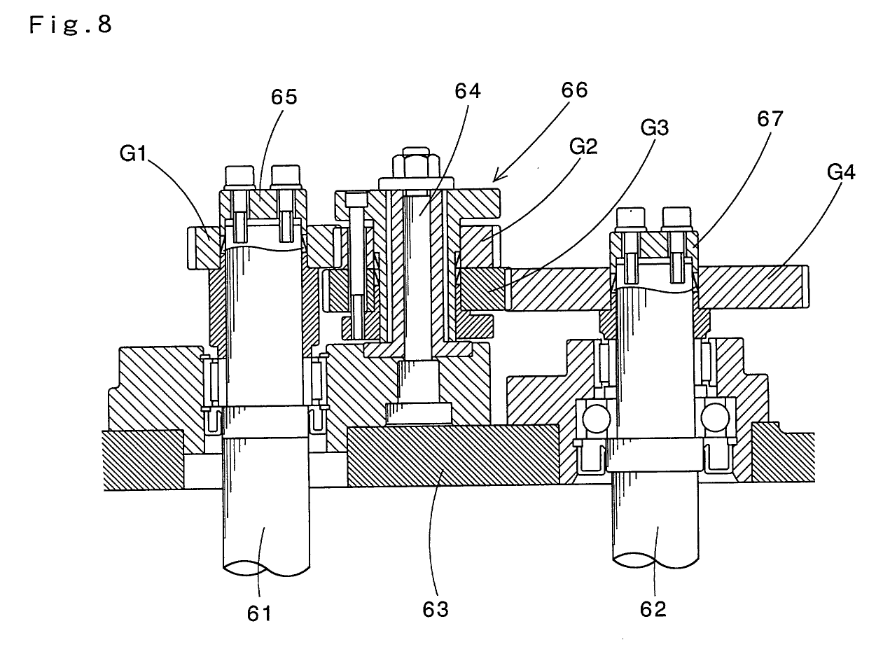

The driving shaft 33 is arranged so as to upwardly project from an upper wall of the main body case 31. Further, as shown in FIG. 3, the driving shaft 33 is connected to the gear system 6 via a pulley 36 mounted to the driving shaft 33, a pulley 37 mounted to the input shaft 61 of the gear system 6 and a belt 38 stretched between the pulleys 36 and 37. As shown in FIG. 8, the gear system 6 has an input shaft 61, an output driving shaft 62, a case 63 rotatably supporting four gears (G1 to G4) and a support shaft 64 capable of mounting interchangeable gears G2 and G3 for making a combination. In this case, the input shaft 61 is mounted with the gear G1; on the other hand, the output driving shaft 62 is mounted with the gear G4.

The input shaft 61 is rotatably mounted to the case 63 via a bearing, and one end of the input shaft 61 is provided with a gear pressure member 65 for rotating the gear G1 together. The gear G2 engaging with the gear G1 is attached to the support shaft 64 via a mounting flange member 66 in a state of overlapping with the gear G3 in the plate thickness direction, and is rotated together with the support shaft 64. The gear G4 is engaged with the gear G3, and is fixedly attached to the output driving shaft 62 via a gear pressure member 67 while being rotated together with the output driving shaft 62. By doing so, a rotating output from the input shaft 61 is transmitted to the output driving shaft 62. In this case, at the point of time when a target (desired) rotating angle is set, previously stocked gears are used as the gears G1 and G4. For this reason, the gears G1 and G4 may be mounted as a generally non-interchangeable gear to the input shaft 61 and the output driving shaft 62, respectively. On the other hand, the gears G2 and G3 may be mounted to the support shaft 64 as an interchangeable gear for setting the rotating angle.

The output driving shaft 62 of the gear system 6 is connected to a rotary driving section (not shown) of the laminating station 51 of the die 5 via pulleys 39, 40 and a belt 41.

Next, an operation of the machining apparatus M having the above structure will be described below with reference to FIG. 1 to FIG. 7.

When the press machine 1 is operated, the feeder 3 feeds the strip material W into the press machine 1. In the die 5, the strip material W is sequentially fed to each station so that each machining can be carried out. In this case, in one rotation of the press machine 1, an upper die is positioned near the upper dead point within a range of the crank angle from 270° to 90° (feed timing). For this reason, the feeder 3 is operated so as to feed the strip material W, and in a range from 90° to 270° (machining timing), the upper die moves down toward a lower die, and thereafter, each pilot punch goes into the strip material W so as to carry out machining.

On the other hand, in the feed timing, a rotation output is transmitted to the crankshaft of the press machine 1 via the belt 8 and the pulley 9. Then, the input shaft 12 of the non-uniform motion head 10 is continuously rotated at a uniform speed while making the same rotation as the crank shaft, and thereby, rotates the first rotating lever 15 along the axial center of the input shaft 12.

The connecting lever 17 is connected to the first rotating lever 15 via the first connecting pin 18; on the other hand, the second connecting pin 19 is connected to the second rotating lever 16 rotating together with the output shaft 13 positioned eccentrically with the input shaft 12. Thus, as shown in FIG. 6, the uniform rotation of the input shaft 12 is transmitted to the output shaft 13 by the non-uniform rotation. The non-uniform rotation output of the output shaft 13 is transmitted to the camshaft 32 of the angle index head 7 via the coupling 20 so as to make an intermittent rotation of the driving shaft 33 of the angle index section. Thereafter, the intermittent rotation is transmitted to the gear system 6. Here, in the case where an output angle θI of the angle index head 7 is set to 60°, in the gear system 6, a rotating angle θ is set to 41.4°±0.10, for example. In this case, the combination of number of gear teeth of four gears settled within the rotating angle 41.40°±0.10 is obtained from the following equation of θ=θI×(N1×N3)/(N2×N4). If the number N1 and N4 of gear teeth of the gears G1 and G4 are set to 68, the number N2 and N3 of gear teeth of the interchangeable gears G2 and G3 are as shown in the following Table 1.

TABLE 1

| N1 | N2 | N3 | N4 | θ |
|---|---|---|---|---|
| 68 | 74 | 51 | 68 | 41.351 |
| 68 | 58 | 40 | 68 | 41.379 |
| 68 | 71 | 49 | 68 | 41.408 |
| 68 | 84 | 58 | 68 | 41.429 |
| 68 | 55 | 38 | 68 | 41.455 |
| 68 | 81 | 56 | 68 | 41.481 |

*The numerical value of N1 to N4 is a number of gear teeth, θI is an output angle (60°) of the angle index head 7, and θ is a rotating angle of the output driving shaft 62.
θ = θI × (N1 × N3)/(N2 × N4)

Therefore, when the intermittent rotation of the driving shaft 33 of the angle index head 7 is transmitted, the gear system 6 intermittently rotates the output driving shaft 62 at a predetermined angle based on any of the combinations of gears shown in the above Table 1. Then, the rotating output of the driving shaft 33 is transmitted to the rotary driving section of the laminating station 51.

For this reason, the laminated core is rotated by a predetermined angle. The laminated core is rotated at a high speed, and thereby, run-out is generated in the laminated core by an inertial force when stopping the rotation.

In this case, in the output shaft 13 of the non-uniform motion head 10 rotating at a non-uniform speed, since the position driven at fast rotation is set during the feed timing, the driving shaft 33 of the angle index head 7 has one index angle rotation as shown in FIG. 7. That is, the rotation is completed before the feed timing of the input shaft 12 of the non-uniform motion head 10 is completed. Therefore, the rotation of the driving shaft 33 is stopped between a stop position corresponding to one index angle and the completion position of the feed timing. As a result, a stop period T is provided until the completion position of the feed timing comes. During the above stop period T, the run-out by the rotation of the laminated core is attenuated; therefore, the laminated core can be arranged at a predetermined position.

When the crank angle comes into the machining timing, the pilot punch attached to the upper die goes into the strip material W. In particular, in the laminating station 51, the pilot punch goes into a predetermined position of the laminated core, then, predetermined machining is carried out together with caulking, and thereafter, a laminated core can be formed.

As described above, in the laminated core machining apparatus M of the present embodiment, the gear system 6 is connected to the angle index head 7, and further, the laminated member is rotated at a predetermined angle. Therefore, the number of gear teeth of the gears G is arbitrarily combined, and thereby, it is possible to arbitrarily set the rotating angle of the laminated member. In addition, the laminated core machining apparatus M is mechanically connected to the press machine 1; therefore, a high-speed operation can be achieved.

Further, the gear system 6 is constructed so that the rotating angle of the output driving shaft 62 is set by the combination of four gears G1, G2, G3, and G4. Thus, when the output angle of the angle index head 7 is set to θ1, and each number of gear teeth of the gears G1, G2, G3, and G4 is set as N1, N2, N3, and N4, the rotating angle of the output driving shaft 62 of the gear system 6 is obtained from the following equation of θ=θI×(N1×N3)/(N2×N4). The combination of four gears G1, G2, G3, and G4 having arbitrary number of teeth is changed, and thereby, it is possible to set an arbitrary rotating angle, and to achieve fine adjustment to the target rotating angle.

Moreover, in the laminated core machining apparatus M of the present invention, the rotation output of the press machine 1 is transmitted to the non-uniform motion mechanism 10. In the non-uniform motion mechanism 10, the rotation output of the input shaft 12 rotating at a uniform speed is transmitted to the output shaft 13 at a non-uniform speed. Thus, the position rotating faster than the input shaft 12 is set during the feed timing of the press machine 1, and thereby, the output driving shaft 62 of the gear system 6 connected to the angle index head 7 reaches the rotation completion position before the feed timing is completed. As a result, the output driving shaft 62 of the gear system 6 has the stop period T until the feed timing is completed after the rotation of the output driving shaft 62 of the gear system 6 is completed. Therefore, the run-out by the rotation of the laminated core is attenuated during the stop period T, and in the case where the upper die pilot punch goes into the laminated member, it goes into the predetermined position, so that the pilot punch has no interference and collision with other portions of the laminated member. Therefore, the mechanically connected laminated core machining apparatus M further makes it possible to achieve a high-speed operation.

In the non-uniform motion mechanism, when the input shaft 12 (rotary shaft of the press machine side) of the non-uniform motion head 10 is rotated, the rotation output is transmitted to the output shaft 13 (rotary shaft of the angle index head side) positioned eccentrically with the input shaft 12 by the connecting lever 17. Therefore, the uniform rotation of the input shaft 12 of the non-uniform motion head 10 is outputted as the non-uniform rotation of the output shaft 13 of the non-uniform motion head 10. In other words, the output driving shaft 62 of the gear system 6 connected to the output shaft 13 of the non-uniform motion head 10 via the angle index head 7 has a forward feed timing with respect to the feed timing of the press machine 1. Thus, the forward feed timing is set during the feed timing of the press machine 1, and thereby, the time rotating and stopping the laminated member comes faster than the completion of the feed timing. Therefore, the stop period T is provided without making small the index angle of the angle index head 7. By doing so, it is possible to attenuate the run-out by the rotation of the laminated member during the above stop period T, and to achieve a high-speed operation without reducing the strength of the angle index head 7.

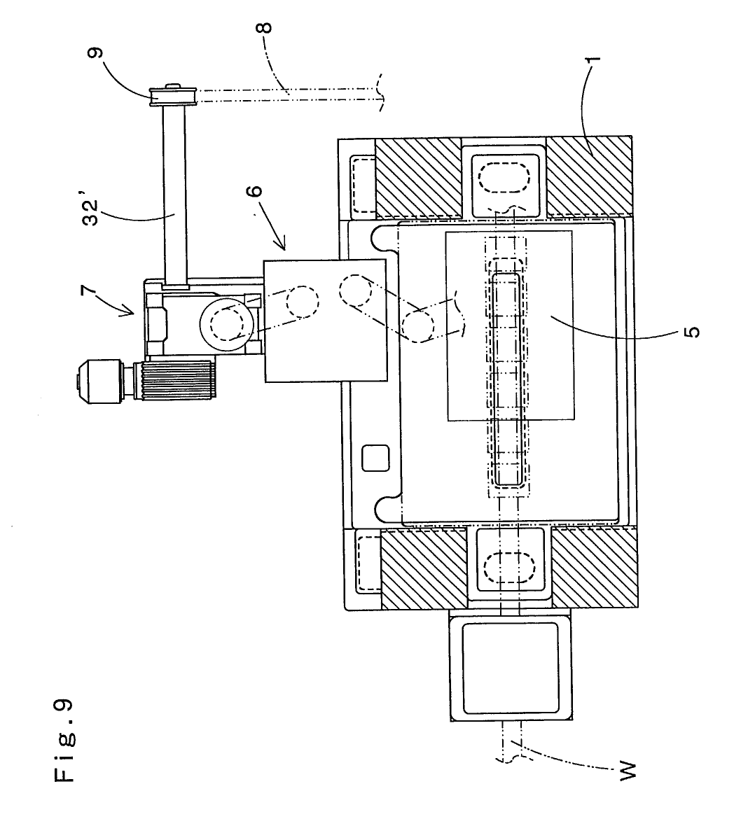

The machining apparatus of the present invention are not limited to the above embodiment. For example, as shown in FIG. 9, the rotation of the crank shaft of the press machine 1 is transmitted directly to the camshaft 32′ of the angle index head 7 via the belt 8 and the pulley 9, excepting the non-uniform motion head 10. Even if the machining apparatus is configured as described above, the number of gear teeth of the above gears G is arbitrarily combined, and thereby, it is possible to arbitrarily set the rotating angle of the laminated member. In addition, the machining apparatus M is mechanically connected to the press machine 1; therefore, a high-speed operation can be achieved.

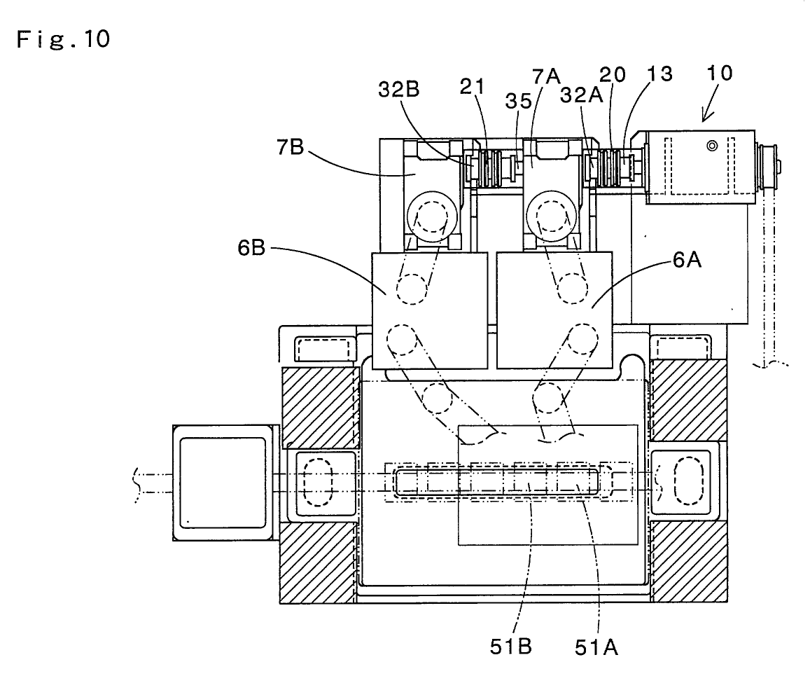

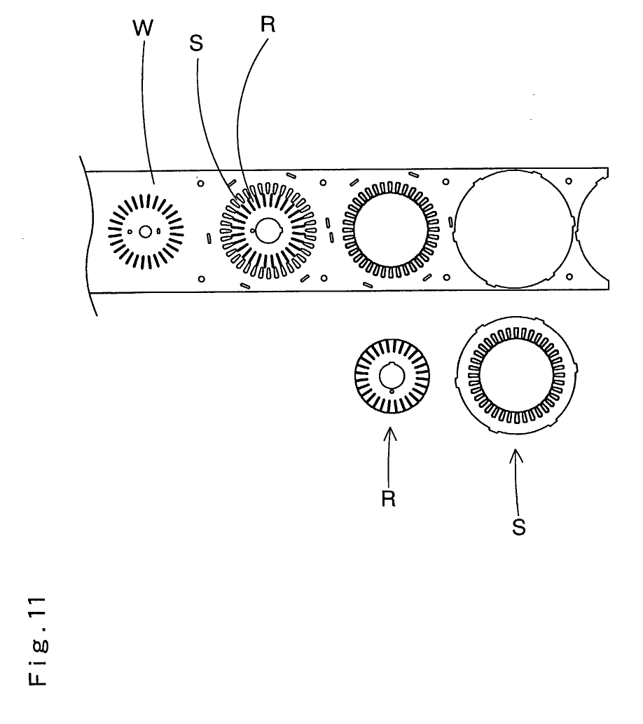

Moreover, a machining apparatus M1 shown in FIG. 10 has the following structure in the case of laminating (e.g., two-stage machining) mutually related two products, that is, a stator S and a rotor R from one strip material, as shown in FIG. 11. The machining apparatus M1 is constructed in a manner that a gear system 6A and an angle index head 7A connected to one laminating station 51A of the stator S are arranged in parallel with a gear system 6B and an angle index head 7B connected to another laminating station 51B of the rotor R. In this case, the output shaft 13 of the non-uniform motion head 10 is connected to a camshaft 32A of the angle index head 7A via the coupling 20. Further, the angle index head 7A is connected to a connecting shaft 35 arranged on the straight line identical to the camshaft 32A of the angle index head 7A and arranged on the side opposite to a main body case 31A of the angle index head 7A. On the other hand, the angle index head 7B is connected to a-camshaft 32B of the angle index head 7B via a coupling 21. Therefore, the non-uniform rotating output of the output shaft 13 of the non-uniform motion head 10 is transmitted from the angle index head 7A to the laminating station 51A of the stator S via the gear system 6A. While the non-uniform rotating output is transmitted from the angle index head 7B to the laminating station 51B of the rotor R via the gear system 6 from the connecting shaft 35 and the coupling 21. By doing so, two-product laminating can be carried out. In the embodiment, the rotating angle in the laminating stations of the stator S and the rotor R is set to an arbitrary rotating angle by changing the combination of the gears G2 and G3 of the gear systems 6A and 6B. Further, the stop period T is provided in the laminating stations 51A and 51B depending on the arrangement of the non-uniform motion head 10.

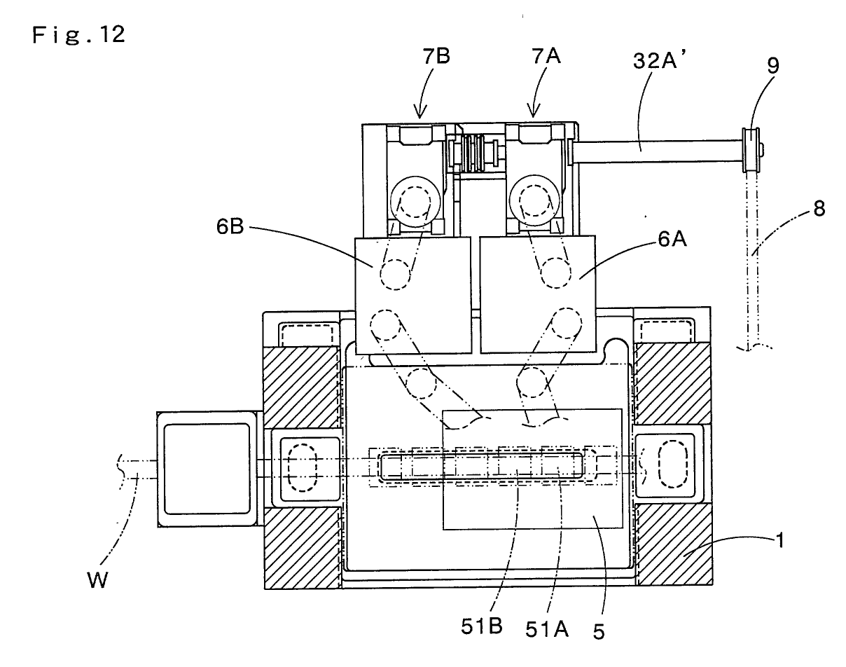

As shown in FIG. 12, in the machining apparatus M1 shown in FIG. 10, the rotating output of the crank shaft may be connected directly to the camshaft 32A′ of the angle index head 7A via the belt 8 and the pulley 9, excepting the non-uniform motion head 10.

What is claimed is:

1. A laminated core machining apparatus, which comprises: a press machine; a feeder for feeding a strip material to the press machine; and an angle index head outputting an intermittent rotation when a drive from the press machine is transmitted thereto, and carries out laminating in a manner of sequentially rotating a laminated member in a laminating process by the angle index head when forwardly feeding the strip material so that a laminated core can be formed,
wherein the apparatus is connected with an angle index head for rotating the laminated member and a gear system connected to the angle index head and having a gear assembly capable of arbitrarily setting an index angle, in the laminating process.

2. The laminated core machining apparatus according to claim 1, wherein the gear system is constructed so that a rotating angle of an output driving shaft can be set by the combination of four kinds of gears.

3. A laminated core machining apparatus, which comprises: a press machine; a feeder for feeding a strip material to the press machine; and an angle index head outputting an intermittent rotation when a drive from the press machine is transmitted thereto, and carries out laminating in a manner of sequentially rotating a laminated member in a laminating process by the index head when forwardly feeding the strip material so that a laminated core can be formed,
wherein the apparatus is connected with an angle index head for rotating the laminated member, and a gear system connected to the angle index head and having a gear assembly capable of arbitrarily setting an index angle, in the laminating process
the angle index head is connected via a non-uniform motion mechanism with respect to a rotating output of the press machine,
an output shaft of the non-uniform motion mechanism has a forward feed timing rotating faster than an input shaft of the non-uniform motion mechanism so that a stop period can be provided between a rotation stop time of the output driving shaft of the gear system and a feed stop time of a feed timing.

4. The laminated core machining apparatus according to claim 3, wherein the input and output shafts of the non-uniform motion mechanism are arranged on a position eccentric with each other, and are connected by a connecting lever, which is rotatably supported to a pin arranged on a position eccentric with each axial center of the input and output shafts.

5. The laminated core machining apparatus according to claim 1, wherein the angle index head and the gear system are arranged in pairs and in parallel to each other, and an output driving shaft of each gear system is connected to the laminating process.

6. The laminated core machining apparatus according to claim 2, wherein the angle index head and the gear system are arranged in pairs and in parallel to each other, and an output driving shaft of each gear system is connected to the laminating process.

7. The laminated core machining apparatus according to claim 3, wherein the angle index head and the gear system are arranged in pairs and in parallel to each other, and an output driving shaft of each gear system is connected to the laminating process.

8. The laminated core machining apparatus according to claim 4, wherein the angle index head and the gear system are arranged in pairs and in parallel to each other, and an output driving shaft of each gear system is connected to the laminating process.
